(19) United States
(12) Patent Application Publication
(10) Pub. No.: US 2018/0306511 A1
(43) Pub. Date: Oct. 25, 2018

(54) COMBUSTION CAN

(71) Applicant: Berry Metal Company, Harmony, PA (US)

(72) Inventor: Michael Mattich, Harmony, PA (US)

(21) Appl. No.: 15/803,175

(22) Filed: Nov. 3, 2017

Related U.S. Application Data
(60) Provisional application No. 62/416,807, filed on Nov. 3, 2016.

(51) Int. Cl. F27B 3/24; F27B 3/08; F27B 3/20; F27B 9/06; F27B 15/16

(52) U.S. Cl. CPC F27B 3/24; F27B 3/085; C21C 5/52; F27B 9/062; F27B 15/16; F27B 3/205

(57) ABSTRACT

A fluid cooled combustion can, comprising: an internal core housed in an intermediate core; wherein the inteimediate core is housed in an external housing; wherein an outer surface of the intermediate core defines one or more ribs that together with an inside surface of the external housing define a cooling fluid circuit that is in fluid communication with a cooling fluid inlet and outlet.

This application claims the benefit of provisional patent application U.S. Ser. No. 62/416,807 filed Nov. 3, 2016, which is incorporated by reference herein for all purposes.

### FIELD OF THE DISCLOSURE

The present disclosure generally relates to an improved fluid cooled enclosure for auxiliary burners used in metal melting, refining and processing, for example, steel making in an electric arc furnace (EAF) or blast furnace.

### BACKGROUND OF THE DISCLOSURE

Generally auxiliary burners are used to assist in the steel making process to add thermal energy by the combustion of fuel, the injection of oxidizing gas for melt refining, foamy slag production or post combustion of carbon monoxide, and the injection of particulates for slag and foamy slag production. In many instances, the oxidizing gas is introduced as a high velocity stream that may exceed sonic velocities.

Existing combustion housings or “cans” for containing such auxiliary burners have various deficiencies that detract from the efficiency and economy of the steelmaking process.

In order to overcome the disadvantages associated with typical combustion cans, it would be desirable to provide a combustion can having a similar geometry to existing combustion cans that is capable of housing an ignitor, a thermocouple and/or a flame-eye; that provides greater cooling efficiency while using less copper metal.

It would also be desirable to provide a combustion can of a hybrid design having an internal core and external housing made of copper and an intermediate core made from steel.

### BRIEF SUMMARY OF THE DISCLOSURE

Many other variations are possible with the present disclosure, and those and other teachings, variations, and advantages of the present disclosure will become apparent from the description and figures of the disclosure.

One aspect of a preferred embodiment of the present disclosure comprises a fluid cooled combustion can, comprising: an internal core housed in an intermediate core; wherein the intermediate core is housed in an external housing; wherein an outer surface of the intermediate core defines one or more ribs that together with an inside surface of the external housing define a cooling fluid circuit that is in fluid communication with a cooling fluid inlet and outlet.

In another aspect of a preferred fluid cooled combustion can of the present disclosure, an inner surface of the intermediate core defines one or more ribs that together with an outer surface of the internal core define a part of the cooling fluid circuit.

In another aspect of a preferred fluid cooled combustion can of the present disclosure, the cooling fluid circuit defines a helical path.

In yet another aspect of a preferred fluid cooled combustion can of the present disclosure, the internal core and external housing are made of a first material and the intermediate core is made from a second material.

In a further aspect of a preferred fluid cooled combustion can of the present disclosure, the internal core and external housing are made of copper and the intermediate core is made from steel.

In another aspect of a preferred fluid cooled combustion can of the present disclosure, the internal core defines a laval nozzle.

Another aspect of a preferred embodiment of the present disclosure comprises a fluid cooled combustion can, comprising: an internal bore housed defined by a combustion can body; and a cooling fluid circuit defined by the combustion can body, wherein the cooling fluid circuit is in fluid communication with a cooling fluid inlet and outlet.

In another aspect of a preferred fluid cooled combustion can of the present disclosure, the cooling fluid circuit defines a helical path.

In an additional aspect of a preferred fluid cooled combustion can of the present disclosure, the internal bore defines a laval nozzle.

### BRIEF DESCRIPTION OF THE SEVERAL VIEWS OF THE DRAWINGS

For the present disclosure to be easily understood and readily practiced, the present disclosure will now be described for purposes of illustration and not limitation in connection with the following figures, wherein:

FIG. 1 shows a perspective view of a preferred combustion can according to the present disclosure;

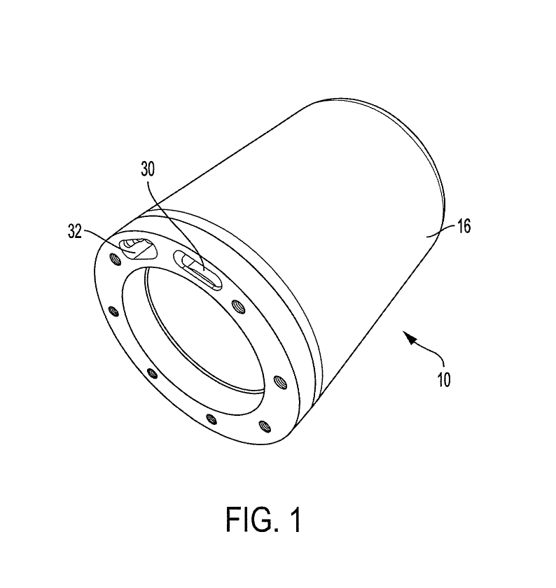

FIG. 2 shows a partial cut-away view of a hybrid copper and steel combustion can according to the present disclosure;

FIG. 3 shows a cross-sectional view of a combustion can according to the present disclosure;

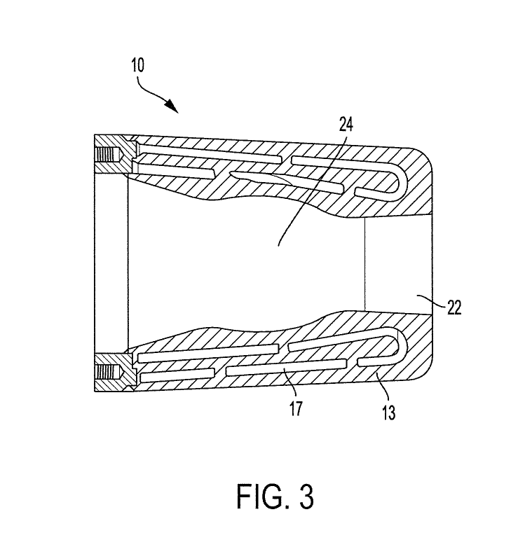

FIG. 4 shows a schematic view of a helical cooling fluid circuit produced in a preferred combustion can according to the present disclosure; and

FIG. 5 shows a preferred mold for use in manufacturing a preferred combustion can according to the present disclosure.

### DETAILED DESCRIPTION

In the following detailed description, reference is made to the accompanying examples and figures that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “disclosure” merely for convenience and without intending to voluntarily limit the scope of this application to any single disclosure or inventive concept if more than one is in fact disclosed.

The following description is, therefore, not to be taken in a limited sense, and the scope of this disclosure is defined by the appended claims.

A preferred fluid cooled combustion can 10, such as for a burner for an EAF (Electric Arc Furnace), blast furnace or other type of metallurgical furnace, of the present disclosure, comprises: an internal core 12 housed in an intermediate core 14; wherein the intermediate core 14 is housed in an external housing 16; wherein an outer surface of the intermediate core 14 defines one or more ribs 15 that together with an inside surface of the external housing 16 defines a cooling fluid circuit 19 that is in fluid communication with a fluid cooling inlet 30 and outlet 32. Ribs 15A disposed on the inner surface of intermediate core 14 also helps to define part of cooling fluid circuit 19 that is in fluid communication with a fluid cooling inlet 30 and outlet 32.

In another aspect of a preferred fluid cooled combustion can 10 of the present disclosure, the cooling fluid circuit 19 defines a helical path.

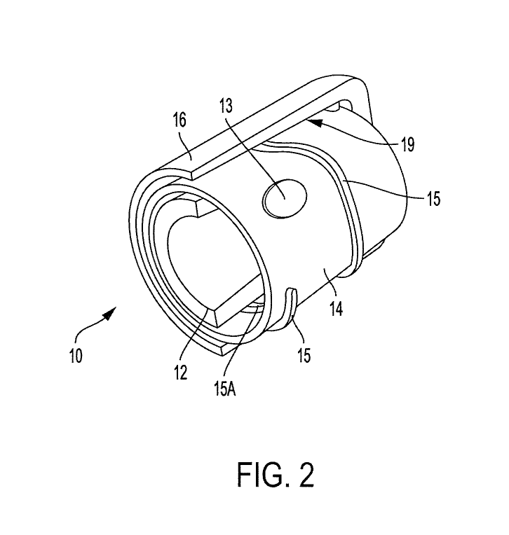

In yet another aspect of a preferred fluid cooled combustion can 10 of the present disclosure, the internal core 12 and external housing 16 are made of a first material and the intermediate core 14 is made from a second material. An opening 13 in intermediate core 14 allows for cooling fluid to flow more readily on both the inner and outer sides of intermediate core 14 as shown in FIG. 2.

In another aspect of a preferred fluid cooled combustion can 10 of the present disclosure, the internal core 12 and external housing 16 are made of copper and the intermediate core 14 is made from steel.

In another aspect of a preferred fluid cooled combustion can 10 of the present disclosure, the internal bore 24 defines a laval nozzle 22.

Another preferred fluid cooled combustion can 10, such as for a burner for an EAF (Electric Arc Furnace), blast furnace or other type of metallurgical furnace, of the present disclosure, comprises: an internal bore 24 defined by the body 13 of the combustion can. The body 13 defines an internal a fluid cooling circuit 17, preferably helical, that is in fluid communication with a fluid cooling inlet and outlet.

In another aspect of a preferred fluid cooled combustion can 10 of the present disclosure, the internal bore 24 defines a laval nozzle 22.

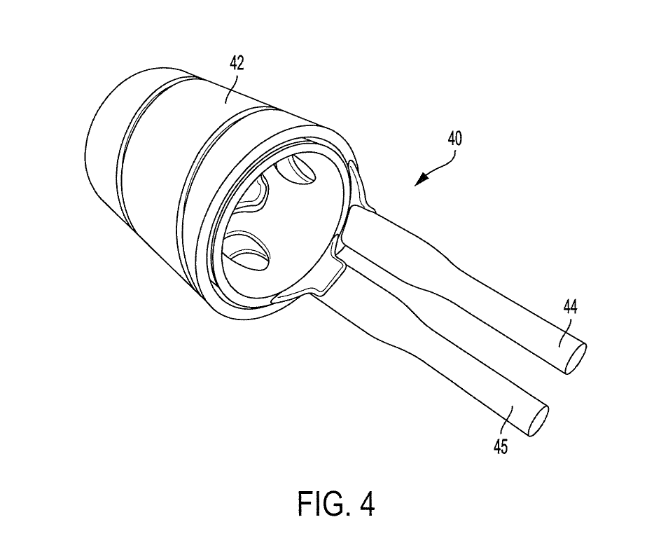

FIG. 4 shows a schematic view of a preferred cooling fluid circuit 40 having a helical section 42 produced by the combustion can 10 of the present disclosure. As shown, inlet flow 44 and outlet flow 45 form part of the cooling fluid circuit 40.

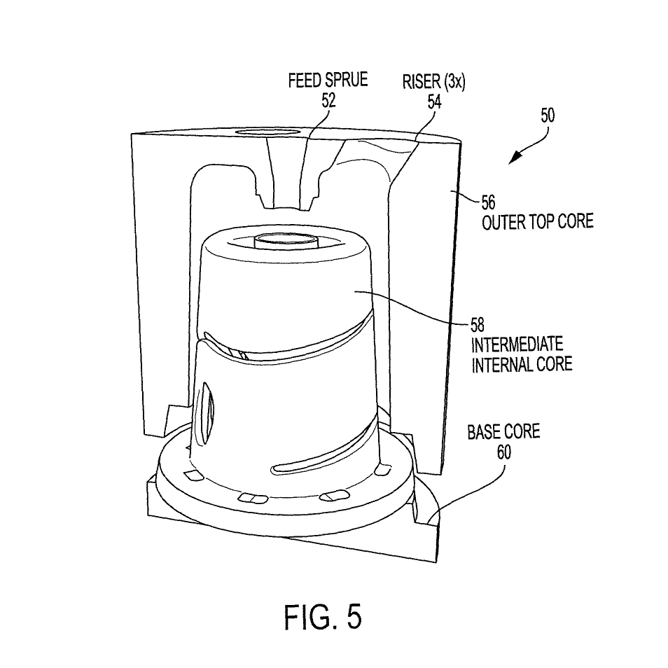

FIG. 5 shows a preferred mold 50 for use in manufacturing a preferred combustion can according to the present disclosure. Mold 50 comprises feed sprue 52, three risers 54, outer top core 56, intermediate internal core 58 and base core 60.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

What is claimed is:

1. A fluid cooled combustion can, comprising:
an internal core housed in an intermediate core; wherein the intermediate core is housed in an external housing;
wherein an outer surface of the intermediate core defines one or more ribs that together with an inside surface of the external housing define a cooling fluid circuit that is in fluid communication with a cooling fluid inlet and outlet.

2. The fluid cooled combustion can of claim 1 wherein an inner surface of the intermediate core defines one or more ribs that together with an outer surface of the internal core define a part of cooling fluid circuit.

3. The fluid cooled combustion can of claim 1 wherein the cooling fluid circuit defines a helical path.

4. The fluid cooled combustion can of claim 2 wherein the cooling fluid circuit defines a helical path.

5. The fluid cooled combustion can of claim 1 wherein the internal core and external housing are made of a first material and the intermediate core is made from a second material.

6. The fluid cooled combustion can of claim 1 wherein the internal core and external housing are made of copper and the intermediate core is made from steel.

7. The fluid cooled combustion can of claim 2 wherein the internal core and external housing are made of a first material and the intermediate core is made from a second material.

8. The fluid cooled combustion can of claim 2 wherein the internal core and external housing are made of copper and the intermediate core is made from steel.

9. The fluid cooled combustion can of claim 1 wherein the internal core defines a laval nozzle.

10. A fluid cooled combustion can, comprising:
an internal bore housed defined by a combustion can body; and
a cooling fluid circuit defined by the combustion can body, wherein the cooling fluid circuit is in fluid communication with a cooling fluid inlet and outlet.

11. The fluid cooled combustion can of claim 10 wherein the cooling fluid circuit defines a helical path.

12. The fluid cooled combustion can of claim 10, wherein the internal bore defines a laval nozzle.
